(19) United States
(12) Patent Application Publication
(10) Pub. No.: US 2018/0347431 A1
(43) Pub. Date: Dec. 6, 2018

(54) HEAT EXCHANGER AND WASTE HEAT RECOVERY STRUCTURE

(71) Applicants: TOYOTA JIDOSHA KABUSHIKI KAISHA, Toyota-shi (JP); IBIDEN CO., LTD., Ogaki (JP)

(72) Inventors: Toshio MURATA, Toyota-shi (JP); Yoshihiro KOGA, Ibi-gun (JP)

(73) Assignees: TOYOTA JIDOSHA KABUSHIKI KAISHA, Toyota-shi (JP); IBIDEN CO., LTD., Ogaki (JP)

(21) Appl. No.: 15/991,772

(22) Filed: May 29, 2018

(30) Foreign Application Priority Data
Jun. 2, 2017 (JP) 2017-109962

(51) Int. Cl. F01N 5/02; F02G 5/02; F28D 21/00; F01N 3/02

(52) U.S. Cl. CPC F01N 5/02; F02G 5/02; F28F 2250/06; F01N 3/0205; F01N 2240/02; F28D 21/0003

(57) ABSTRACT

A heat exchanger includes an introduction path and a discharge path. The introduction path introduces the heating medium to upstream portions of heating medium passages. A length of the introduction path along a third direction is reduced gradually from an upstream end portion of the introduction path towards a downstream end portion of the introduction path. The discharge path discharges the heating medium to an outlet portion. A length of the discharge path along the third direction increases gradually from a first portion towards a second portion. The first portion is disposed downstream of the upstream end portion of the introduction path in the flow direction, and the second portion is disposed downstream of the downstream end portion of the introduction path in the flow direction.

### INCORPORATION BY REFERENCE

The disclosure of Japanese Patent Application No. 2017-109962 filed on Jun. 2, 2017 including the specification, drawings and abstract is incorporated herein by reference in its entirety.

### BACKGROUND

### 1. Technical Field

The disclosure relates to a heat exchanger and a waste heat recovery structure.

### 2. Description of Related Art

In Japanese Unexamined Patent Application No. 2016-200071 (JP 2016-200071 A), a gas cooler is disclosed. In the gas cooler, heat is exchanged between a heating medium such as coolant introduced through an inlet pipe, and exhaust gas. With the gas cooler described in JP 2016-200071 A, a plurality of heating medium passages, and a plurality of gas passages are disposed alternately in a width direction of the gas cooler. In the heating medium passages, the heating medium introduced through the inlet pipe flows, and, in the gas passages, the exhaust gas flows. The inlet pipe is disposed so as to be close to one side of the width direction of the gas cooler.

### SUMMARY

In the gas cooler described in JP 2016-200071 A, there is a case where the heating medium from the inlet pipe is caused to flow in the width direction of the gas cooler and introduced into each of the heating medium passages. In this case, compared to the heating medium passages disposed on one side of the width direction of the gas cooler (an upstream side of a flow direction), which is closer to the inlet pipe, resistance on the heating medium is higher in the heating medium passages disposed on the other side of the width direction of the gas cooler (a downstream side of the flow direction), which is far from the inlet pipe.

As a result, there are cases where flow rates of the heating medium flowing in the heating medium passages vary among the heating medium passages. Variation in flow rate of the heating medium flowing in the heating medium passages among the heating medium passages causes partial boiling of the heating medium and deterioration of heat exchange efficiency.

In consideration of the above-mentioned fact, an object of the disclosure is to obtain a heat exchanger and a waste heat recovery structure that are able to improve heat exchange efficiency.

A heat exchanger according to a first aspect of the disclosure includes a heat exchanger body, a plurality of gas passages, a plurality of heating medium passages, an inlet portion, an outlet portion, an introduction path, and a discharge path. The heat exchanger body has a size in a first direction, a second direction, and a third direction that are orthogonal to each other. The gas passages go through the heat exchanger body in the first direction in a state where the gas passages are partitioned from the inside of the heat exchanger body. The gas passages are disposed in the second direction, and allow high-temperature gas to flow to one side of the first direction. The heating medium passages are formed inside the heat exchanger body, disposed alternately with the gas passages in the second direction, and allow heating medium to flow in a flow direction along the one side or the other side of the first direction. The heating medium exchanges heat with high-temperature gas flowing in the gas passages. The inlet portion is provided in the heat exchanger body and introduces the heating medium from the outside to the inside of the heat exchanger body. The outlet portion is provided in the heat exchanger body and discharges the heating medium from the inside to the outside of the heat exchanger body. The introduction path is formed inside the heat exchanger body, and allows the heating medium introduced from the inlet portion to flow in the second direction, and thus introduces the heating medium to upstream portions of the heating medium passages. A length of the introduction path along the third direction is reduced gradually from an upstream end portion of the introduction path towards a downstream end portion of the introduction path. The discharge path is formed inside the heating exchanger body, allows the heating medium discharged from the downstream portions of the heating medium passages to flow in the second direction and thus discharges the heating medium to the outlet portion. A length of the discharge path along the third direction increases gradually from a first portion towards a second portion. The first portion is disposed downstream of the upstream end portion of the introduction path in the flow direction, and the second portion is disposed downstream of the downstream end portion of the introduction path in the flow direction.

The “first direction”, the “second direction”, and the “third direction” in the first aspect are “arbitrary directions” that are orthogonal to one another. The “arbitrary directions” mean “directions including one arbitrary direction and its opposite direction”. Therefore, as examples of the “first direction”, the “second direction”, and the “third direction”, a “front-rear direction”, a “right-left direction”, and an “upward-downward direction” may be used, respectively. Further, when the “front-rear direction” is used as an example of the “first direction”, “one side in the first direction” is a “front side” or a “rear side”. “The other side in the first direction” is the opposite direction of the “one side in the first direction”, and, when the “front side” is used as an example of the “one side in the first direction”, “the other side in the first direction” is the “rear side”.

The expression “disposed alternately” in the first aspect includes a case where more than one set of a single or a plurality of gas passages, and more than one set of a single or a plurality of heating medium passages are disposed alternately.

With the heat exchanger according to the first aspect, the high-temperature gas flows to one side in the first direction in the gas passages that go through the heat exchanger body in the first direction in a state where the gas passages are partitioned from the inside of the heat exchanger body.

Meanwhile, the heating medium is introduced via the inlet portion to the inside of the heat exchanger body from the outside of the heat exchanger body. The heating medium flows in the introduction path in the second direction, and is introduced to the upstream portions of the heating medium passages. The heating medium flows in the heating medium passages in the flow direction along the one side or the other side in the first direction, and exchanges heat with high-temperature gas flowing in the gas passages. Then, the heating medium flows in the discharge path in the second direction from downstream portions of the heating medium passages, and is discharged from the outlet portion to outside of the heat exchanger body.

Here, the length of the introduction path along the third direction is reduced gradually from the upstream end portion of the introduction path towards the downstream end portion of the introduction path. This means that the length of the introduction path along the third direction is reduced gradually from the upstream end portion close to the inlet portion towards the downstream end portion far from the inlet portion. Thus, the longer a distance from the inlet portion becomes, the smaller a sectional area of the introduction path becomes.

Meanwhile, the length of the discharge path along the third direction increases gradually from the first portion towards the second portion. The first portion is disposed downstream of the upstream end portion of the introduction path in the flow direction (a downstream side of the flow direction of the heating medium flowing in the heating medium passages), and the second portion is disposed downstream of the downstream end portion of the introduction path.

The first portion of the discharge path is disposed downstream of the upstream end portion of the introduction path in the flow direction. Hence, the heating medium flowing in the heating medium passages in the flow direction from the upstream end portion of the introduction path close to the inlet portion is discharged to the first portion of the discharge path. The second portion of the discharge path is disposed downstream of the downstream end portion of the introduction path in the flow direction. Therefore, the heating medium flowing in the heating medium passages in the flow direction from the downstream end portion of the introduction path far from the inlet portion is discharged to the second portion of the discharge path.

As described above, the length of the discharge path along the third direction increases gradually from the first portion towards the second portion. Therefore, on a discharge side of the heating medium passages disposed on a side far from the inlet portion, a sectional area of the discharge path is larger than that on a discharge side of the heating medium passages disposed on a side close to the inlet portion.

As described so far, the longer a distance from the inlet portion, the smaller the sectional area of the introduction path becomes. Also, on the discharge side of the heating medium passages disposed on the side far from the inlet portion, the sectional area of the discharge path is larger than that on the discharge side of the heating medium passages disposed on the side close to the inlet portion. Thus, it is possible to restrain variation in flow resistance among a plurality of routes from the inlet portion to the outlet portion through respective heating medium routes. Accordingly, the heating medium flowing in the heating medium passages is restrained from having variation in flow rate between the heating medium passages disposed on the side close to the inlet portion and the heating medium passages disposed on the side far from the inlet portion. Thus, with the configuration, the heating medium flowing in the heating medium passages is restrained from having variation in flow rate among the heating medium passages. Therefore, heat exchange efficiency is improved.

In the heat exchanger according to the first aspect, the inlet portion may communicate with a first end portion of the introduction path on one side in the second direction, the outlet portion may communicate with a second end portion of the discharge path on the other side in the second direction, and the introduction path may allow the heating medium introduced from the inlet portion to flow from the one side to the other side, and thus may introduce the heating medium to the upstream portions of the heating medium passages. The length of the introduction path along the third direction may be reduced gradually from the first end portion on the one side to a second end portion of the other side. The discharge path may allow the heating medium discharged from the downstream portions of the heating medium passages to flow from the one side to the other side, and thus discharge the heating medium to the outlet portion. The length of the discharge path along the third direction may increase gradually from a first end portion on the one side serving as the first portion to the second end portion on the other side serving as the second portion.

With the heat exchanger according to the above structure, the length of the introduction path along the third direction is reduced gradually from the first end portion on the one side to the second end portion on the other side in the second direction. Thus, the length of the introduction path along the third direction is reduced gradually from the first end portion closer to the inlet portion to the second end portion far from the inlet portion. Accordingly, the longer a distance from the inlet portion becomes, the smaller a sectional area of the introduction path becomes.

Meanwhile, the length of the discharge path along the third direction increases gradually from the first end portion to the second end portion in the second direction

Here, the heating medium flowing in the heating medium passages in the flow direction from the first end portion of the introduction path close to the inlet portion is discharged to the first end portion of the discharge path. The heating medium flowing in the heating medium passages in the flow direction from the second end portion of the introduction path far from the inlet portion is discharged to the second end portion of the discharge path.

As described above, the length of the discharge path along the third direction increases gradually from the first end portion towards the second end portion. Therefore, on a discharge side of the heating medium passages disposed on a side far from the inlet portion, a sectional area of the discharge path is larger than that on a discharge side of the heating medium passages disposed on a side close to the inlet portion.

As described so far, the inlet portion and the outlet portion are disposed on the one side and the other side in the second direction, respectively, and the longer a distance from the inlet portion becomes, the smaller the sectional area of the introduction path becomes. Also, on the discharge side of the heating medium passages disposed on the side far from the inlet portion, the sectional area of the discharge path is larger than that on the discharge side of the heating medium passages disposed on the side close to the inlet portion. Thus, it is possible to restrain variation in flow resistance among a plurality of routes from the inlet portion to the outlet portion through respective heating medium routes. Accordingly, the heating medium flowing in the heating medium passages is restrained from having variation in flow rate between the heating medium passages disposed on the side close to the inlet portion and the heating medium passages disposed on the side far from the inlet portion. With the configuration in which the inlet portion communicates with the first end portion of the introduction path, and the outlet portion communicates with the second end portion of the discharge path, the heating medium flowing in the heating medium passages is restrained from having variation in flow rate among the heating medium passages. Therefore, heat exchange efficiency is improved.

In the heat exchanger according to the first aspect, the inlet portion may communicate with a portion of the introduction path on a center side in the second direction, and the outlet portion may communicate with a portion of the discharge path on a center side in the second direction. The introduction path may allow the heating medium introduced from the inlet portion to flow from the center side to the one side and the other side in the second direction, and thus may introduce the heating medium to the upstream portions of the heating medium passages. A length of the introduction path along the third direction may be reduced gradually from the portion on the center side to first and second end portions on the one side and the other side. The discharge path may allow the heating medium discharged from the downstream portions of the heating medium passages to flow from the one side and the other side to the center side, and thus may discharge the heating medium to the outlet portion. A length of the discharge path along the third direction may increase gradually from a portion on the center side serving as the first portion to first and second end portions on the one side and the other side, serving as the second portions.

With the heat exchanger according to above structure, the length of the introduction path along the third direction is reduced gradually from the portion on the center side (hereinafter, referred to as a center portion) to the first end portion on the one side and the second end portion on the other side in the second direction. This means that the length of the introduction path along the third direction is reduced gradually from the center portion close to the inlet portion towards the first end portion and the second end portion that are far from the inlet portion. Accordingly, the longer a distance from the inlet portion becomes, the smaller a sectional area of the introduction path becomes.

Meanwhile, the length of the discharge path along the third direction increases gradually from the center portion to the first end portion and the second end portion in the second direction.

Here, the heating medium flowing in the heating medium passages in the flow direction from the center portion of the introduction path close to the inlet portion is discharged to the center portion of the discharge path. The heating medium flowing in the heating medium passages in the flow direction from the first end portion and the second end portion of the introduction path far from the inlet portion is discharged to the first end portion and the second end portion of the discharge path, respectively.

As described above, the length of the discharge path along the third direction increases gradually from the center portion to the first end portion and the second end portion. Therefore, on a discharge side of the heating medium passages disposed on a side far from the inlet portion, a sectional area of the discharge path is larger than that on a discharge side of the heating medium passages disposed on a side close to the inlet portion.

As described so far, the inlet portion and the outlet portion are disposed in the center portions in the second direction, respectively. Thus, the longer a distance from the inlet portion becomes, the smaller the sectional area of the introduction path becomes. Also, on the discharge side of the heating medium passages disposed on the side far from the inlet portion, the sectional area of the discharge path is larger than that on the discharge side of the heating medium passages disposed on the side close to the inlet portion. Thus, it is possible to restrain variation in flow resistance among a plurality of routes from the inlet portion to the outlet portion through respective heating medium routes. Accordingly, the heating medium flowing in the heating medium passages is restrained from having variation in flow rate between the heating medium passages disposed on the side close to the inlet portion and the heating medium passages disposed on the side far from the inlet portion. As described above, with the configuration in which the inlet portion communicates with the center portion of the introduction path, and the outlet portion communicates with the center portion of the discharge path, the heating medium flowing in the heating medium passages are also restrained from having variation in flow rate among the heating medium passages. Therefore, heat exchange efficiency is improved.

In the heat exchanger according to the first aspect, the inlet portion may communicate with a first end portion of the introduction path on one side in the second direction, and the outlet portion may communicate with a first end portion of the discharge path on the one side in the second direction. The introduction path may allow the heating medium introduced from the inlet portion to flow from the one side to the other side in the second direction, and thus may introduce the heating medium to the upstream portions of the heating medium passages. A length of the introduction path along the third direction may be reduced gradually from the first end portion on the one side to the second end portion on the other side. The discharge path may allow the heating medium discharged from the downstream portions of the heating medium passages to flow from the other side to the one side, and thus discharges the heating medium to the outlet portion. A length of the discharge path along the third direction may increase gradually from the first end portion on the one side serving as the first portion to a second end portion on the other side serving as the second portion.

With the heat exchanger according to the above structure, the length of the introduction path along the third direction is reduced gradually from the first end portion on the one side to the second end portion on the other side in the second direction. This means that the length of the introduction path along the third direction is reduced gradually from the first end portion close to the inlet portion towards the second end portion far from the inlet portion. Accordingly, the longer a distance from the inlet portion becomes, the smaller a sectional area of the introduction path becomes.

Meanwhile, the length of the discharge path along the third direction increases gradually from the first end portion to the second end portion in the second direction.

Here, the heating medium flowing in the heating medium passages in the flow direction from the first end portion of the introduction path close to the inlet portion is discharged to the first end portion of the discharge path. The heating medium flowing in the heating medium passages in the flow direction from the second end portion of the introduction path far from the inlet portion is discharged to the second end portion of the discharge path.

As described above, the length of the discharge path along the third direction increases gradually from the first end portion to the second end portion. Therefore, on a discharge side of the heating medium passages disposed on a side far from the inlet portion, a sectional area of the discharge path is larger than that on a discharge side of the heating medium passages disposed on a side close to the inlet portion.

As described so far, the inlet portion and the outlet portion are disposed on the same side in the second direction, and the longer a distance from the inlet portion becomes, the smaller the sectional area of the introduction path becomes. Also, on the discharge side of the heating medium passages disposed on the side far from the inlet portion, the sectional area of the discharge path is larger than that on the discharge side of the heating medium passages disposed on the side close to the inlet portion. Thus, it is possible to restrain variation in flow resistance among a plurality of routes from the inlet portion to the outlet portion through respective heating medium routes. Accordingly, the heating medium flowing in the heating medium passages is restrained from having variation in flow rate between the heating medium passages disposed on the side close to the inlet portion and the heating medium passages disposed on the side far from the inlet portion. With the above configuration in which the inlet portion communicates with the first end portion of the introduction path, and the outlet portion communicates with the first end portion of the discharge path, the heating medium flowing in the heating medium passages is also restrained from having variation in flow rate among the heating medium passages. Therefore, heat exchange efficiency is improved.

In the heat exchanger according to the first aspect, the heat exchanger body, the inlet portion, and the outlet portion may be formed integrally from silicon carbide.

With the heat exchanger according to the above structure, the heat exchanger body, the inlet portion, and the outlet portion are formed integrally from silicon carbide that has excellent thermal conductivity. Therefore, it is possible to improve heat exchange performance.

In a second aspect of the disclosure, a waste heat recovery structure includes an exhaust pipe in which exhaust gas flows, and the heat exchanger according to the first aspect. In the heat exchanger, the heat exchanger body is provided inside the exhaust pipe, and the exhaust gas serving as high-temperature gas flows in the gas passages.

In the heat exchanger used in the waste heat recovery structure according to the second aspect, the heating medium flowing in the heating medium passages is restrained from having variation in flow rate between the heating medium passages. Therefore, it is possible to improve heat exchange efficiency. As a result, in the waste heat recovery structure, recovery efficiency of heat recovery from exhaust gas is improved.

Since the disclosure has the foregoing configurations, the heating medium flowing in the heating medium passages is restrained from having variation in flow rate among the heating medium passages, thereby improving heat exchange efficiency.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view of a waste heat recovery structure according to an embodiment;

FIG. 2 is a perspective view of a heat exchanger according to the embodiment;

FIG. 3 is an exploded perspective view of the heat exchanger according to the embodiment;

FIG. 4 is a perspective view of the partially-cut heat exchanger according to the embodiment;

FIG. 5 is a perspective view of the partially-cut heat exchanger according to the embodiment;

FIG. 6 is a sectional view of the heat exchanger according to the embodiment, taken along the line 6-6 in FIG. 2;

FIG. 7 is a plan view of the heat exchanger according to the embodiment;

FIG. 8 is a perspective view of a heat exchanger according to a first modification;

FIG. 9 is a plan view of the heat exchanger according to the first modification;

FIG. 10A is a sectional view of the heat exchanger according to the first modification, taken along the line 10A-10A in FIG. 9;

FIG. 10B is a sectional view taken along the line 10B-10B in FIG. 9;

FIG. 11 is a perspective view of a heat exchanger according to a second modification;

FIG. 12 is a plan view of the heat exchanger according to the second modification;

FIG. 13A is a sectional view of the heat exchanger according to the second modification, taken along the line 13A-13A in FIG. 12; and

FIG. 13B is a sectional view taken along the line 13B-13B in FIG. 12.

### DETAILED DESCRIPTION OF EMBODIMENTS

Hereinafter, an example of an embodiment according to the disclosure is described based on the drawings.

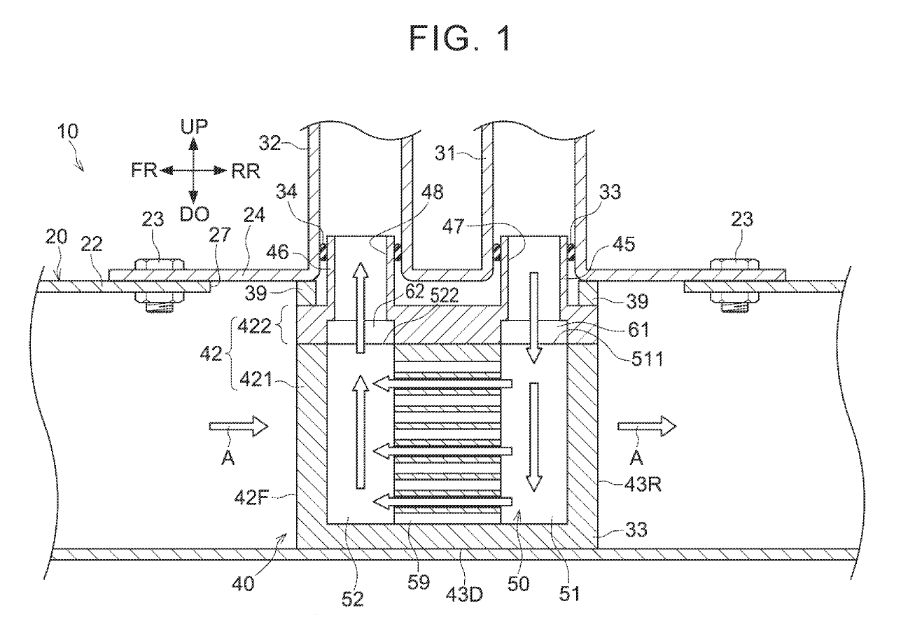

A waste heat recovery structure 10 according to a first embodiment is described. FIG. 1 is a sectional view of the waste heat recovery structure 10. Arrow FR, arrow RR, arrow LH, arrow RH, arrow UP, and arrow DO shown in each of the drawings as appropriate indicate a front direction, a rear direction, a left direction, a right direction, an upward direction, and a downward direction, respectively. Because these directions are decided for convenience of explanation, directions in the waste heat recovery structure 10 are not limited to these directions. Also, front-rear, right-left, and upward-downward directions used in the following description may or may not coincide with front-rear, right-left, and upward-downward directions, respectively, of a vehicle to which the waste heat recovery structure 10 is applied.

The drawings used in the following description each are schematic views that conceptually show the waste heat recovery structure 10, and there are cases where dimensional ratios of each component shown in each of the drawings in the front-rear direction, the right-left direction, and the upward-downward direction are different among the drawings. Also, a “planar view” used in the following description means a view from an upper side to a lower side, and includes a case where a part of a component is seen through. Further, a “front view” used in the following description means a view from a front side to a rear side, and includes a case where a part of a component is seen through.

The waste heat recovery structure 10 is a structure that recovers heat of exhaust gas emitted from an engine (not shown) of a vehicle such as an automobile. Specifically, as shown in FIG. 1, the waste heat recovery structure 10 includes an exhaust pipe 20, a heat exchanger 40, an introduction pipe 31, a discharge pipe 32, and O-rings 33, 34.

The exhaust pipe 20 is made of a cylindrical pipe. The exhaust gas flows inside the exhaust pipe 20 to the rear. In each of the drawings, a gas flow direction in which exhaust gas flows is shown by the direction of arrow A. Specifically, the exhaust pipe 20 has an exhaust pipe body 22 and a cover portion 24.

The exhaust pipe body 22 is made of a cylindrical pipe. In the exhaust pipe body 22, a storing opening 27 is formed so as to store the heat exchanger 40 inside the exhaust pipe body 22. The cover portion 24 covers the storing opening 27, and is also fixed to the exhaust pipe body 22 by, for example, fastening members 23. The introduction pipe 31 and the discharge pipe 32 are provided integrally with the cover portion 24. To be specific, a downstream end portion (a lower end portion) of the introduction pipe 31, and an upstream end portion (a lower end portion) of the discharge pipe 32 are connected with the cover portion 24. Exhaust gas has temperature in a range of, for example, 200° C. or higher and 800° C. or lower.

The heat exchanger 40 has a function of exchanging heat between exhaust gas that flows in the exhaust pipe 20, and a heating medium. As the heating medium, for example, coolant (LLC: long life coolant) for cooling an engine is used. The heating medium has temperature lower than that of exhaust gas. When coolant is used as the heating medium, temperature of the heating medium is, for example, about 130° C. at most.

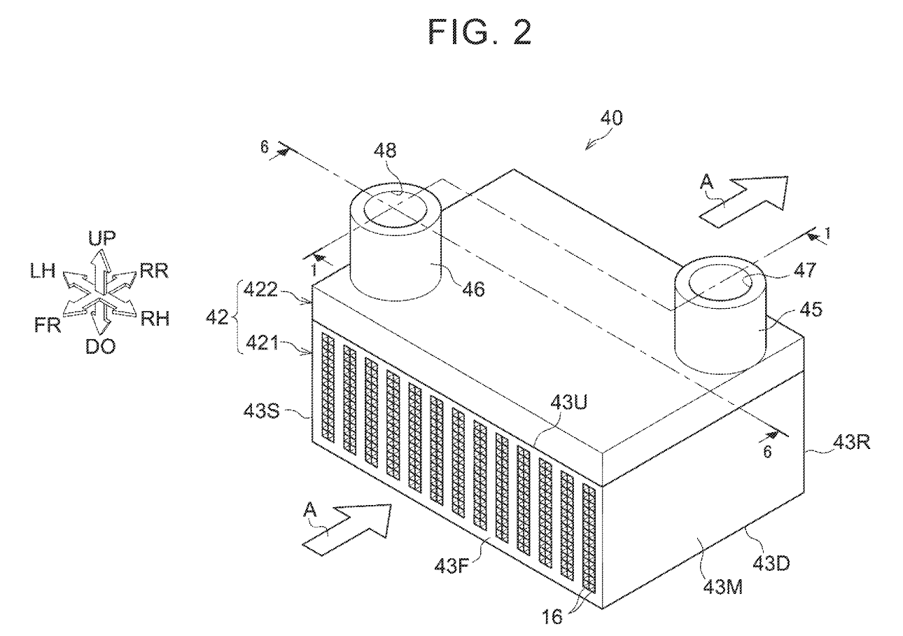

Specifically, as shown in FIG. 2, the heat exchanger 40 includes a heat exchanger body 42, an inlet portion 45, and an outlet portion 46. As shown in FIG. 1, the heat exchanger body 42 is disposed inside the exhaust pipe 20. The heat exchanger 40 shown in FIG. 1 is shown as a section that is taken along the line 1-1 in FIG. 2.

As shown in FIG. 2, the heat exchanger body 42 has its size in the front-rear direction (an example of a first direction), the right-left direction (an example of a second direction), and the upward-downward direction (an example of a third direction) that are orthogonal to each other. To be specific, the heat exchanger body 42 is formed into a rectangular parallelepiped shape. The heat exchanger body 42 includes a first flow passage forming body 421, and a second flow passage forming body 422.

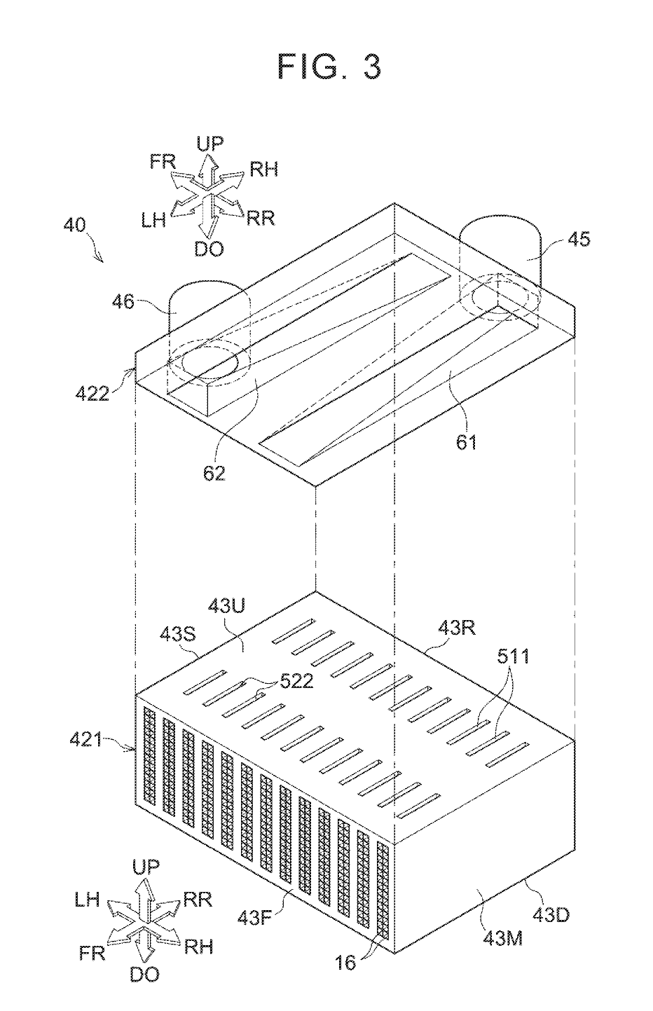

As shown in FIG. 3, the first flow passage forming body 421 is formed into a rectangular parallelepiped shape. Therefore, the first flow passage forming body 421 includes a front surface 43F, a rear surface 43R, a right side surface 43M, a left side surface 43S, an upper surface 43U, and a lower surface 43D.

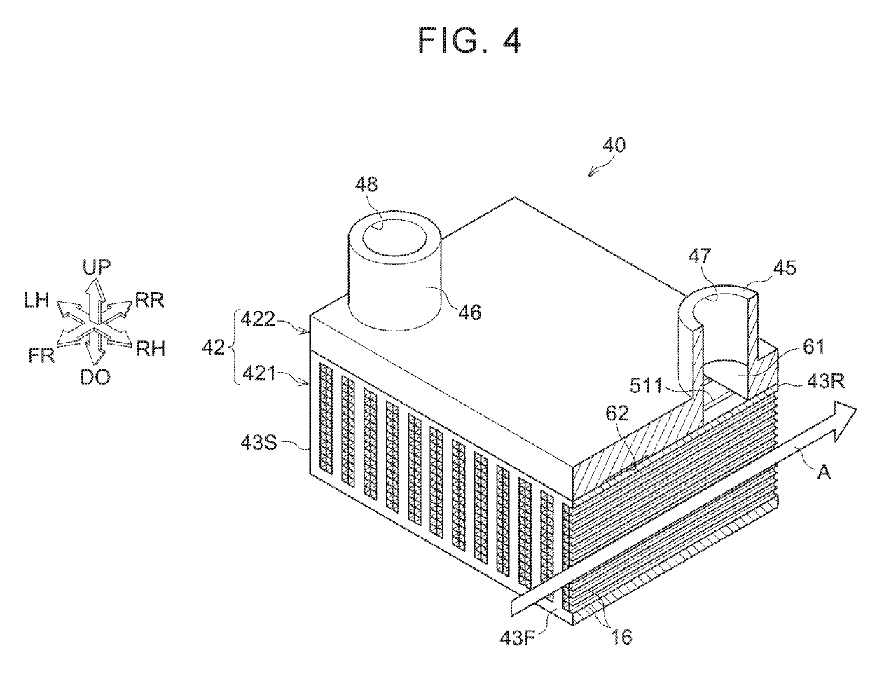

As shown in FIG. 3 and FIG. 4, gas passages 16 go through the first flow passage forming body 421 in the front-rear direction in a state where the gas passages 16 are partitioned from the inside of the first flow passage forming body 421 (the heat exchanger body 42). In the gas passages 16, exhaust gas (an example of high-temperature gas) is able to flow to the rear (one side in the first direction). This means that the gas passages 16 go through the first flow passage forming body 421 from the front surface 43F to the rear surface 43R of the first flow passage forming body 421.

The plurality of gas passages 16 is disposed both in the upward-downward direction and in the right-left direction. Thus, in a view towards the front surface 43F of the first flow passage forming body 421, the gas passages 16 are disposed in a two-dimensional manner. In the embodiment, a set of two rows of the gas passages 16 is disposed at intervals in the right-left direction. Each of the rows is made of the gas passages 16 disposed in the upward-downward direction.

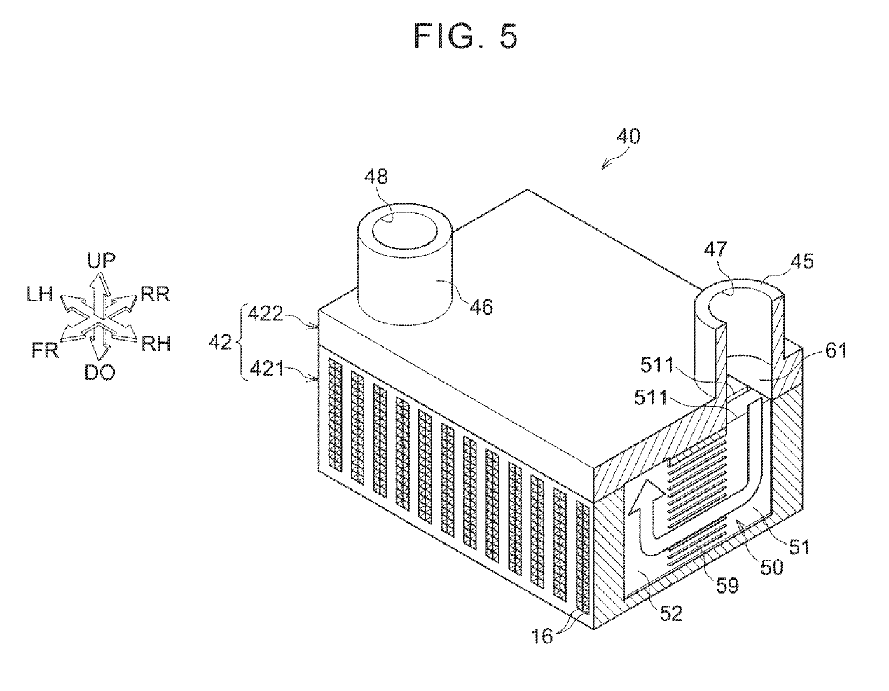

As shown in FIG. 1 and FIG. 5, heating medium passages 50 are formed inside of the first flow passage forming body 421 (the heat exchanger body 42). In the heating medium passages 50, the heating medium is able to flow to the front (an example of a flow direction along the one side or the other side in the first direction). The heating medium passages 50 are partitioned from the gas passages 16 by partitions 17. Then, the heating medium flowing in the heating medium passages 50 to the front exchanges heat through the partitions 17 with exhaust gas flowing in the gas passages 16 to the rear.

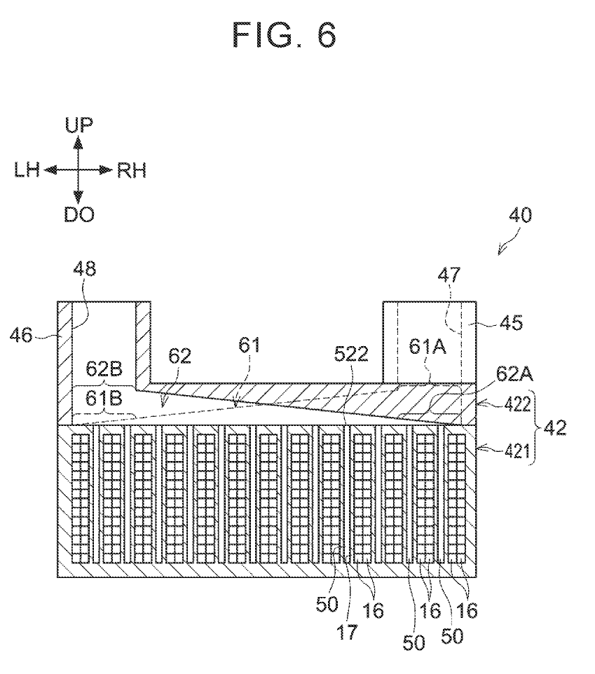

As shown in FIG. 6, the heating medium passages 50 and the gas passages 16 are disposed alternately in the right-left direction. Specifically, more than one set of two of the gas passages 16 and one of the heating medium passages 50 is disposed alternately in the right-left direction. The numbers of the gas passages 16 and the heating medium passages 50 disposed in the right-left direction are not limited to the numbers stated above. More than one set of a single or a plurality of the gas passages 16 and a single or a plurality of the heating medium passages 50 may be disposed alternately in the right-left direction. The heat exchanger 40 shown in FIG. 6 is shown as a section taken along the line 6-6 in FIG. 2.

As shown in FIG. 1 and FIG. 5, a plurality of passages 59 partitioned from one another in the upward-downward direction is formed in a center portion of each of the heating medium passages 50 in the front-rear direction. As the heating medium flowing in the heating medium passage 50 passes the passages 59, the heating medium is rectified.

As described above, in the heating medium passages 50, the heating medium flows to the front. Therefore, a rear portion (a portion on the rear side with respect to the passages 59) of the heating medium passage 50 serves as an upstream portion 51 of the heating medium passage 50. Further, a front portion (a portion on the front side with respect to the passages 59) of the heating medium passage 50 serves as a downstream portion 52 of the heating medium passage 50.

As shown in FIG. 1, in each of the upstream portions 51, an introduction port 511 that opens upwardly is formed. The heating medium is introduced to the heating medium passages 50 through the introduction ports 511. In each of the downstream portions 52, a discharge port 522 that opens upwardly is formed. The heating medium is discharged from the heating medium passages 50 through the discharge ports 522.

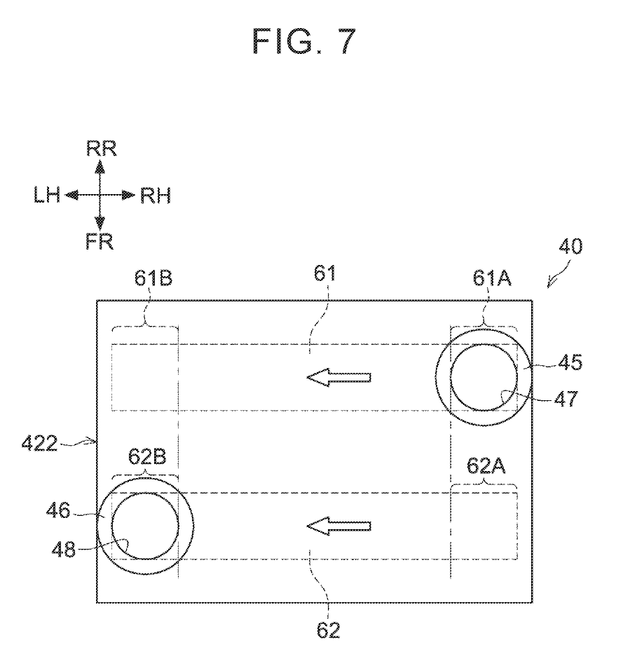

As shown in FIG. 7, the second flow passage forming body 422 is formed into a plate shape (see FIG. 3) that has a rectangular shape in a planar view, and has a thickness direction in the upward-downward direction. As shown in FIG. 2, the second flow passage forming body 422 is provided integrally with an upper surface of the first flow passage forming body 421. Thus, by providing the first flow passage forming body 421 and the second flow passage forming body 422 integrally with each other, the heat exchanger body 42 is configured.

The inside of the heat exchanger body 42 is a space where the heating medium flows, and partitioned from the gas passages 16. Therefore, the inside of the heat exchanger body 42 does not communicate with the gas passages 16, and serves as a space isolated from the gas passages 16. Further, in the embodiment, the heat exchanger body 42 including the inlet portion 45 and the outlet portion 46 (the second flow passage forming body 422 and the first flow passage forming body 421) is formed integrally from silicon carbide.

The inlet portion 45 shown in FIG. 2 is a port that introduces the heating medium to the inside of the heat exchanger body 42 from outside. Meanwhile, the outlet portion 46 is a port that discharges the heating medium from the inside of the heat exchanger body 42 to outside.

As shown in FIG. 2, the inlet portion 45 and the outlet portion 46 are provided in an upper surface of the second flow passage forming body 422. Specifically, the inlet portion 45 and the outlet portion 46 extend upwardly from the upper surface of the second flow passage forming body 422. Both the inlet portion 45 and the outlet portion 46 are formed into a tubular shape (specifically, a cylindrical shape) having an axis direction in the upward-downward direction.

To be specific, as shown in FIG. 7, the inlet portion 45 is disposed in a rear right portion of the second flow passage forming body 422. The outlet portion 46 is disposed in a front left portion of the second flow passage forming body 422. Thus, the inlet portion 45 and the outlet portion 46 are disposed in diagonal portions of the second flow passage forming body 422 having the rectangular shape in a planar view.

Further, as shown in FIG. 1, a distal end portion of the inlet portion 45 projects to radially outside of the exhaust pipe body 22 of the exhaust pipe 20. Inside the inlet portion 45, a flow passage 47 that allows the heating medium to flow is formed. A distal end portion of the outlet portion 46 projects to radially outside of the exhaust pipe body 22 of the exhaust pipe 20. In the outlet portion 46, a flow passage 48 that allows the heating medium to flow is formed.

The introduction pipe 31 is an introduction pipe that introduces the heating medium to the flow passage 47 in the inlet portion 45 from outside of the exhaust pipe 20. A downstream end portion (a lower end portion) of the introduction pipe 31 and the inlet portion 45 are connected with each other. To be specific, the distal end portion of the inlet portion 45 is inserted into the downstream end portion of the introduction pipe 31. The O-ring 33 is disposed between an inner surface of the introduction pipe 31 and an outer surface of the inlet portion 45, thereby sealing a space between the inner surface of the introduction pipe 31 and the outer surface of the inlet portion 45.

The discharge pipe 32 is a discharge pipe that discharges the heating medium from the flow passage 48 in the outlet portion 46 to outside of the exhaust pipe 20. An upstream end portion (a lower end portion) of the discharge pipe 32 and the outlet portion 46 are connected with each other. To be specific, the distal end portion of the outlet portion 46 is inserted into the upstream end portion of the discharge pipe 32. The O-ring 34 is disposed between an inner surface of the discharge pipe 32 and an outer surface of the outlet portion 46, thereby sealing a space between the inner surface of the discharge pipe 32 and the outer surface of the outlet portion 46.

A space between the inlet portion 45 and the outlet portion 46, and the cover portion 24 of the exhaust pipe 20 is sealed by a sealing material 39 that is disposed in the upper surface of the second flow passage forming body 422. In a planar view, the sealing material 39 is formed into a frame shape that surrounds the inlet portion 45 and the outlet portion 46.

As shown in FIG. 3, in a lower surface of the second flow passage forming body 422, an introduction path 61 and a discharge path 62 are formed. The introduction path 61 introduces the heating medium from the inlet portion 45 to the heating medium passages 50. The discharge path 62 discharges the heating medium from the heating medium passages 50 to the outlet portion 46.

As shown in FIG. 7, the introduction path 61 is disposed along the right-left direction in a rear side portion of the second flow passage forming body 422. The introduction path 61 is formed into a belt shape (a rectangular shape) that extends in the right-left direction in a planar view.

The introduction path 61 communicates with each of the introduction ports 511 (see FIG. 3) of the heating medium passages 50. Also, a right end portion 61A of the introduction path 61 communicates with the flow passage 47 in the inlet portion 45. The introduction path 61 allows the heating medium from the inlet portion 45 to flow to the left and introduces the heating medium into the upstream portions 51 (see FIG. 1) of the heating medium passages 50. As shown in FIG. 7, the inlet portion 45 is disposed so as to overlap the right end portion 61A of the introduction path 61 in a planar view.

A width of the introduction path 61 in the front-rear direction is equal to or larger than a length of each of the introduction ports 511 of the heating medium passages 50 in the front-rear direction. As shown in FIG. 7, the width of the introduction path 61 in the front-rear direction is constant in the right-left direction. Further, the length of the introduction path 61 in the right-left direction is equal to or larger than a length of a space between a right end of the rightmost introduction port 511 and a left end of the leftmost introduction port 511. Each of the introduction ports 511 is disposed within the width of the introduction path 61 in the front-rear direction and the length of the introduction path 61 in the right-left direction. Thus, each of the introduction ports 511 is disposed between a front end and a rear end of the introduction path 61 and between a left end and a right end of the introduction path 61.

As shown in FIG. 6, a height of the introduction path 61 along the upward-downward direction (an example of a length along the third direction) is reduced gradually from the right end portion 61A (an example of an upstream end portion, an example of an end portion on the one side) towards a left end portion 61B (an example of a downstream end portion, an example of an end portion on the other side) of the introduction path 61. To be specific, in a front view, the introduction path 61 is formed into a tapered shape in which the height is reduced gradually from the right side to the left side.

The right end portion 61A of the introduction path 61 is a portion in an upstream end of a flow direction (leftward) in which the heating medium is caused to flow by the introduction path 61. This means that the right end portion 61A is an end portion close to the inlet portion 45. The right end portion 61A communicates with the flow passage 47 in the inlet portion 45, and also communicates with the rightmost introduction port 511. Further, the height of the introduction path 61 is set to be the largest in the right end portion 61A.

The left end portion 61B of the introduction path 61 is a portion in a downstream end of the flow direction (leftward) in which the heating medium is caused to flow by the introduction path 61. This means that the left end portion 61B is an end portion far from the inlet portion 45. The left end portion 61B communicates with the leftmost introduction port 511. Further, the height of the introduction path 61 is set to be the smallest in the left end portion 61B.

As shown in FIG. 7, the discharge path 62 is disposed along the right-left direction in a front side portion of the second flow passage forming body 422. In a planar view, the discharge path 62 is formed into a belt shape (a rectangular shape) that extends in the right-left direction.

The discharge path 62 communicates with each of the discharge ports 522 (see FIG. 3) of the heating medium passages 50. A left end portion 62B of the discharge path 62 communicates with the flow passage 48 in the outlet portion 46. The discharge path 62 allows the heating medium from the downstream portions 52 (see FIG. 1) of the heating medium passages 50 to flow to the left, and discharges the heating medium to the outlet portion 46. As shown in FIG. 7, in a planar view, the outlet portion 46 is disposed so as to overlap the left end portion 62B of the discharge path 62.

A width of the discharge path 62 in the front-rear direction is equal to or larger than a length of each of the discharge ports 522 of the heating medium passages 50 in the front-rear direction. As shown in FIG. 7, the width of the discharge path 62 in the front-rear direction is constant in the right-left direction. Further, a length of the discharge path 62 in the right-left direction is equal to or larger than a length of a space between a right end of the rightmost discharge port 522 and a left end of the leftmost discharge port 522. Each of the discharge ports 522 is disposed within the width of the discharge path 62 in the front-rear direction, and the length of the discharge path 62 in the right-left direction. Thus, each of the discharge ports 522 is disposed between a front end and a rear end of the discharge path 62, and between a left end and a right end of the discharge path 62.

As shown in FIG. 6, a height of the discharge path 62 along the upward-downward direction (an example of a length along the third direction) increases gradually from a right end portion 62A (an example of a first portion, an example of an end portion of the one side) to the left end portion 62B (an example of a second portion, an example of an end portion on the other side) of the discharge path 62. To be specific, in a front view, the discharge path 62 is formed into a tapered shape in which the height increases gradually from the right side to the left side.

The right end portion 62A of the discharge path 62 is a portion in an upstream end of a flow direction (leftward) in which the heating medium is caused to flow by the discharge path 62. The right end portion 62A communicates with the rightmost discharge port 522. Further, as shown in FIG. 7, the right end portion 62A is a portion that is disposed in front of the right end portion 61A of the introduction path 61. Thus, the right end portion 62A is an example of the first portion that is disposed in front (the downstream side of the flow direction of the heating medium flowing in the heating medium passages 50) of the right end portion 61A (the upstream end portion) of the introduction path 61. As shown in FIG. 6, in a front view, the right end portion 62A partially overlaps the right end portion 61A of the introduction path 61. Further, the height of the discharge path 62 is set to be the smallest in the right end portion 62A.

The left end portion 62B of the discharge path 62 is a portion in a downstream end of the flow direction (leftward) in which the heating medium is caused to flow by the discharge path 62. The left end portion 62B communicates with the flow passage 48 in the outlet portion 46, and also communicates with the leftmost discharge port 522. Further, as shown in FIG. 7, the left end portion 62B is a portion that is disposed in front of the left end portion 61B of the introduction path 61. Thus, the left end portion 62B is an example of the second portion that is disposed in front (the downstream side of the flow direction of the heating medium flowing in the heating medium passages 50) of the left end portion 61B (the downstream end portion) of the introduction path 61. As shown in FIG. 6, in a front view, the left end portion 62B partially overlaps the left end portion 61B of the introduction path 61. The height of the discharge path 62 is set to be the largest in the left end portion 62B.

As shown in FIG. 2, because the second flow passage forming body 422 is provided integrally with the upper surface of the first flow passage forming body 421, an opening of the introduction path 61 on the lower side partially communicates with the introduction ports 511 of the heating medium passages 50, and the remaining part of the opening is closed. Also, because the second flow passage forming body 422 is provided integrally with the upper surface of the first flow passage forming body 421, an opening of the discharge path 62 on the lower side partially communicates with the discharge ports 522 of the heating medium passages 50, and the remaining part of the opening is closed. Thus, the introduction path 61 and the discharge path 62 are formed inside the heat exchanger body 42 in which the first flow passage forming body 421 and the second flow passage forming body 422 are provided integrally.

Next, action effects of the first embodiment are described.

In the waste heat recovery structure 10 according to the first embodiment (see FIG. 1), exhaust gas inside the exhaust pipe 20 flows through the gas passages 16 (see FIG. 4) of the heat exchanger 40 to the rear (direction A).

Meanwhile, as shown in FIG. 1, the heating medium is introduced via the introduction pipe 31 from outside of the exhaust pipe 20 into the right end portion 61A (see FIG. 7) of the introduction path 61 through the flow passage 47 in the inlet portion 45. The heating medium introduced into the right end portion 61A of the introduction path 61 flows in the introduction path 61 to the left, and then is introduced to each of the heating medium passages 50 through each of the introduction ports 511 (see FIG. 1 and FIG. 5). The heating medium introduced into each of the heating medium passages 50 flows to the front, and exchanges heat with exhaust gas flowing in the gas passages 16.

The heating medium after heat exchange with exhaust gas is discharged to the discharge path 62 through each of the discharge ports 522. The heating medium discharged to the discharge path 62 flows in the discharge path 62 to the left (see FIG. 7), and then is discharged to outside of the exhaust pipe 20 through the flow passage 48 in the outlet portion 46, and the discharge pipe 32 (see FIG. 1). Thus, heat of exhaust gas flowing in the exhaust pipe 20 is recovered. Then, the heat is reused outside of the exhaust pipe 20.

In the embodiment, as shown in FIG. 6, the height of the introduction path 61 is gradually reduced from the right end portion 61A towards the left end portion 61B of the introduction path 61. This means that the height of the introduction path 61 is reduced gradually from the right end portion 61A close to the inlet portion 45 to the left end portion 61B far from the inlet portion 45. Therefore, the longer a distance from the inlet portion 45 becomes, the smaller a sectional area of the introduction path 61 becomes.

Meanwhile, the height of the discharge path 62 increases gradually from the right end portion 62A to the left end portion 62B in the discharge path 62.

Here, the right end portion 62A of the discharge path 62 is disposed in front of the right end portion 61A of the introduction path 61. Therefore, the heating medium flowing in the heating medium passages 50 to the front from the right end portion 61A of the introduction path 61 close to the inlet portion 45 is discharged to the right end portion 62A of the discharge path 62.

The left end portion 62B of the discharge path 62 is disposed in front of the left end portion 61B of the introduction path 61. Therefore, the heating medium flowing in the heating medium passages 50 to the front from the left end portion 61B of the introduction path 61 far from the inlet portion 45 is discharged to the left end portion 62B of the discharge path 62.

As described earlier, the height of the discharge path 62 increases gradually from the right end portion 62A to the left end portion 62B of the discharge path 62. Therefore, on a discharge side of the heating medium passages 50 that are disposed on a side far from the inlet portion 45 (the left side), a sectional area of the discharge path 62 becomes larger than that on a discharge side of the heating medium passages 50 that are disposed on a side close to the inlet portion 45 (the right side).

As described so far, the sectional area of the introduction path 61 is reduced gradually from the right end portion 61A close to the inlet portion 45 to the left end portion 61B far from the inlet portion 45. Also, the sectional area of the discharge path 62 is larger on the discharge side of the heating medium passages 50 on the side far from the inlet portion 45 (the left side) than that on the discharge side of the heating medium passages 50 on the side close to the inlet portion 45 (the right side). Thus, it is possible to restrain variation in flow resistance among a plurality of routes from the inlet portion 45 to the outlet portion 46 through the respective heating medium passages 50. Hence, the heating medium flowing in the heating medium passages 50 is restrained from having variation in flow rate between the heating medium passages 50 disposed on the side close to the inlet portion 45 (the right side) and the heating medium passages 50 disposed on the side far from the inlet portion 45 (the left side). Since the heating medium flowing in the heating medium passages 50 is restrained from having variation in flow rate among the heating medium passages 50, it is possible to improve heat exchange efficiency.

A heat exchanger 140 according to a first modification is described. Here, only differences from the heat exchanger 40 described above are described, and description of the equivalent parts is omitted. Further, the same reference numerals are used for parts having the same functions as those in the heat exchanger 40.

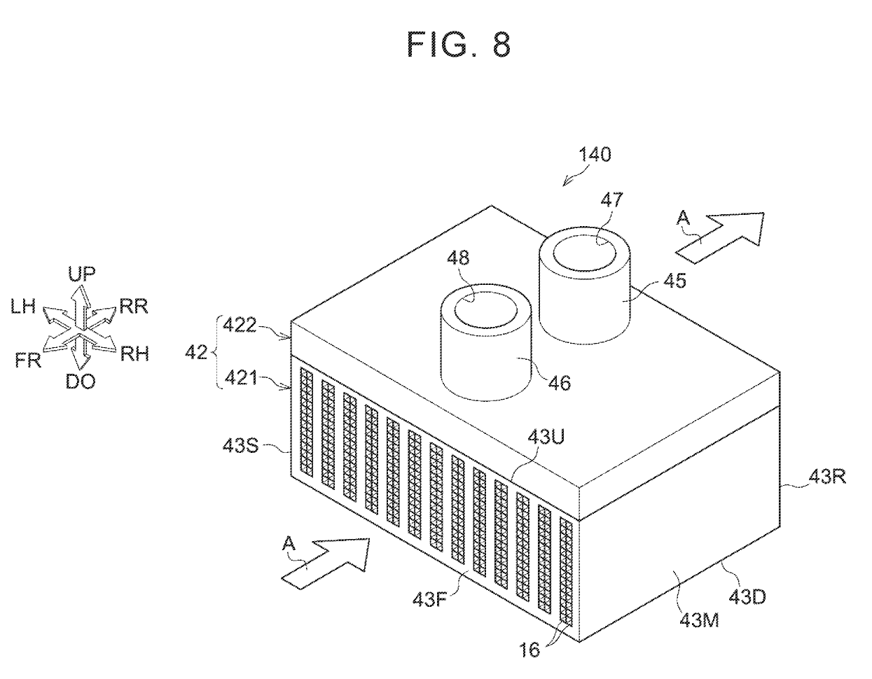

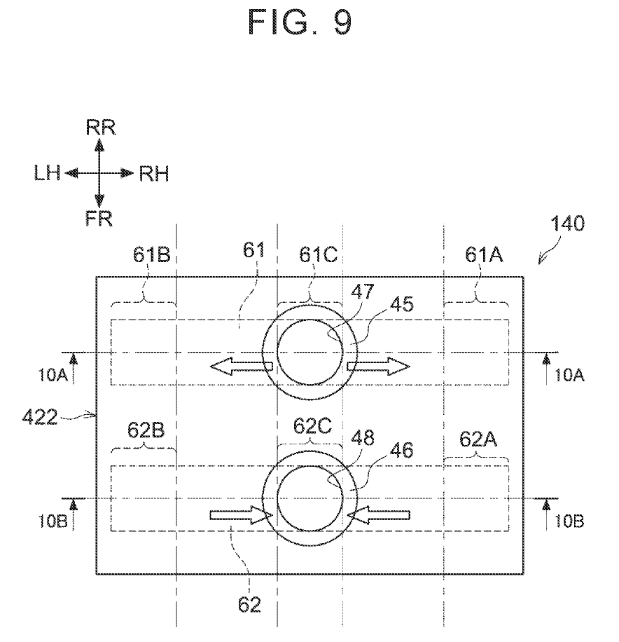

As shown in FIG. 8 and FIG. 9, in the heat exchanger 140 according to the first modification, the inlet portion 45 is disposed in a portion on the rear side and the center side of the second flow passage forming body 422 in the right-left direction. The outlet portion 46 is disposed in a portion on the front side and the center side of the second flow passage forming body 422 in the right-left direction. The first flow passage forming body 421 of the heat exchanger 140 is structured similarly to the first flow passage forming body 421 of the heat exchanger 40.

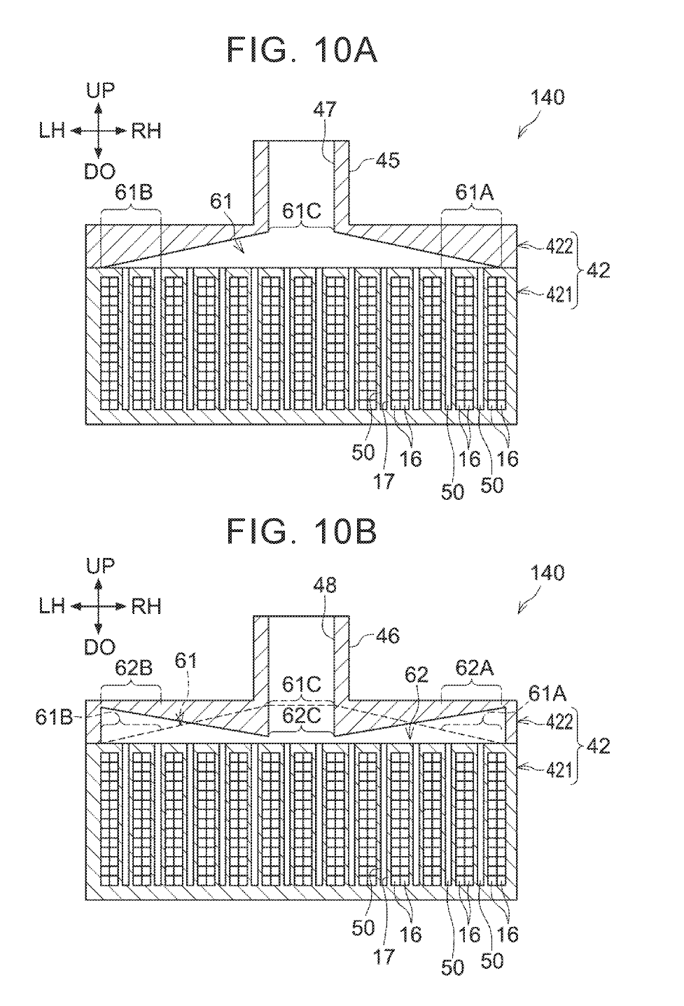

Further, as shown in FIG. 9, FIG. 10A, and FIG. 10B, a center portion 61C of the introduction path 61 in the right-left direction communicates with the flow passage 47 in the inlet portion 45. Then, the introduction path 61 allows the heating medium from the inlet portion 45 to flow from the center portion 61C in the left direction and the right direction, thereby introducing the heating medium into the upstream portions 51 (see FIG. 1) of the heating medium passages 50. As shown in FIG. 9, in a planar view, the inlet portion 45 is disposed so as to overlap the center portion 61C of the introduction path 61.

As shown in FIG. 10A, a height of the introduction path 61 along the upward-downward direction (an example of the length along the third direction) is reduced gradually from the center portion 61C (an example of the upstream end portion, an example of a portion on a center side) towards the right end portion 61A and the left end portion 61B (examples of the downstream end portion, examples of the end portions on one side and the other side) of the introduction path 61. To be specific, in a front view, the introduction path 61 is formed into a generally triangle shape (a generally isosceles triangle shape) in which the height is reduced gradually from the center portion 61C towards the right end portion 61A and the left end portion 61B.

The center portion 61C of the introduction path 61 is a portion of an upstream end in a flow direction (a direction from the center to the left and right sides) in which the heating medium is caused to flow by the introduction path 61. Thus, the center portion 61C is an end portion close to the inlet portion 45. The center portion 61C communicates with the flow passage 47 in the inlet portion 45, and also communicates with the introduction port 511 (see FIG. 3) disposed in the center side in the right-left direction. The height of the introduction path 61 is set to be the largest in the center portion 61C.

The right end portion 61A and the left end portion 61B of the introduction path 61 are portions of downstream ends of the flow direction (the direction from the center to the left and right sides) in which the heating medium is caused to flow by the introduction path 61. Thus, the right end portion 61A and the left end portion 61B are end portions far from the inlet portion 45. Further, the height of the introduction path 61 is set to be the smallest in the right end portion 61A and the left end portion 61B.

Further, a center portion 62C of the discharge path 62 communicates with the flow passage 48 in the outlet portion 46. The discharge path 62 allows the heating medium from the downstream portions 52 (see FIG. 1) of the heating medium passages 50 to flow from the right end portion 62A and the left end portion 62B to the center portion 62C, and then discharges the heating medium to the outlet portion 46. As shown in FIG. 9, in a planar view, the outlet portion 46 is disposed so as to overlap the center portion 62C of the discharge path 62.

As shown in FIG. 10B, a height of the discharge path 62 along the upward-downward direction (an example of a length along the third direction) increases gradually from the center portion 62C (an example of the first portion, an example of a portion on the center side) of the discharge path 62 to the right end portion 62A and the left end portion 62B (examples of the second portion, examples of the end portions on the one side and the other side). To be specific, in a front view, the discharge path 62 is formed into a generally V-shape in which the height increases gradually from the center portion 62C to the right end portion 62A and the left end portion 62B.

The center portion 62C of the discharge path 62 is a portion of a downstream end of a flow direction (a direction from the right side and the left side to the center) in which the heating medium is caused to flow by the discharge path 62. The center portion 62C communicates with the flow passage 48 in the outlet portion 46, and also communicates with the discharge port 522 (see FIG. 3) disposed on the center side in the right-left direction. Further, as shown in FIG. 9, the center portion 62C is a portion disposed in front of the center portion 61C (the upstream end portion) of the introduction path 61. This means that the center portion 62C is an example of the first portion that is disposed in front (a downstream side of a flow direction of the heating medium flowing in the heating medium passages 50) of the center portion 61C (the upstream end portion) of the introduction path 61. As shown in FIG. 10B, in a front view, the center portion 62C overlaps a part of the center portion 61C of the introduction path 61. Further, the height of the discharge path 62 is set to be the smallest in the center portion 62C.

The right end portion 62A and the left end portion 62B of the discharge path 62 are portions of upstream ends of the flow direction (the direction from the right side and the left side to the center) in which the heating medium is caused to flow by the discharge path 62. Further, as shown in FIG. 9, the right end portion 62A and the left end portion 62B are portions that are disposed in front of the right end portion 61A and the left end portion 61B (the downstream end portions) of the introduction path 61, respectively. Thus, the right end portion 62A and the left end portion 62B are examples of the second portions that are disposed in front (the downstream side of the flow direction of the heating medium flowing in the heating medium passages 50) of the right end portion 61A and the left end portion 61B (the downstream end portions) of the introduction path 61, respectively. As shown in FIG. 10B, in a front view, the right end portion 62A and the left end portion 62B partially overlap the right end portion 61A and the left end portion 61B of the introduction path 61, respectively. Further, the height of the discharge path 62 is set to be the largest in the right end portion 62A and the left end portion 62B.

As shown in FIG. 10A, in the heat exchanger 140, the height of the introduction path 61 along the upward-downward direction (an example of the length along the third direction) is reduced gradually from the center portion 61C towards the right end portion 61A and the left end portion 61B of the introduction path 61. Thus, the height of the introduction path 61 is reduced gradually from the center portion 61C close to the inlet portion 45 to the right end portion 61A and the left end portion 61B that are far from the inlet portion 45. Therefore, the longer a distance from the inlet portion 45 becomes, the smaller a sectional area of the introduction path 61 becomes.

Meanwhile, as shown in FIG. 10B, the height of the discharge path 62 along the upward-downward direction (an example of the length along the third direction) increases gradually from the center portion 62C of the discharge path 62 towards the right end portion 62A and the left end portion 62B.

Here, the center portion 62C of the discharge path 62 is disposed in front of the center portion 61C of the introduction path 61. Therefore, the heating medium flowing in the heating medium passages 50 to the front from the center portion 61C of the introduction path 61 close to the inlet portion 45 is discharged to the center portion 62C of the discharge path 62.

The right end portion 62A and the left end portion 62B of the discharge path 62 are disposed in front of the right end portion 61A and the left end portion 61B of the introduction path 61, respectively. Therefore, the heating medium flowing in the heating medium passages 50 to the front from the right end portion 61A and the left end portion 61B of the introduction path 61 far from the inlet portion 45 is discharged to the right end portion 62A and the left end portion 62B of the discharge path 62, respectively.

As described earlier, the height of the discharge path 62 increases gradually from the center portion 62C towards the right end portion 62A and the left end portion 62B of the discharge path 62. Therefore, on the discharge side of the heating medium passages 50 disposed on sides far from the inlet portion 45 (the right side and the left side), a sectional area of the discharge path 62 becomes larger than that on the discharge side of the heating medium passages 50 disposed on a side close to the inlet portion 45 (the center side).

As described so far, the sectional area of the introduction path 61 is reduced gradually from the center portion 61C close to the inlet portion 45 towards the right end portion 61A and the left end portion 61B that are far from the inlet portion 45. Also, on the discharge side of the heating medium passages 50 disposed on the sides far from the inlet portion 45 (the right side and the left side), the sectional area of the discharge path 62 becomes larger than that on the discharge side of the heating medium passages 50 disposed on the side close to the inlet portion 45 (the center side). Thus, it is possible to restrain variation in flow resistance among a plurality of routes from the inlet portion 45 to the outlet portion 46 through the respective heating medium passages 50. Thus, the heating medium flowing in the heating medium passages 50 is restrained from having variation in flow rate between the heating medium passages 50 disposed on the side close to the inlet portion 45 (the center side), and the heating medium passages 50 disposed on the sides far from the inlet portion 45 (the right side and the left side). As described above, in the heat exchanger 140 in which the inlet portion 45 communicates with the center portion 61C of the introduction path 61, and the outlet portion 46 communicates with the center portion 62C of the discharge path 62, the heating medium flowing in the heating medium passages 50 is also restrained from having variation in flow rate among the heating medium passages 50. Therefore, it is possible to improve heat exchange efficiency.

A heat exchanger 240 according to a second modification is described. Here, only differences from the heat exchanger 40 described earlier are described, and description of the equal parts is omitted as necessary. Also, the same reference numerals are used for parts having the same functions as those of the heat exchanger 40.

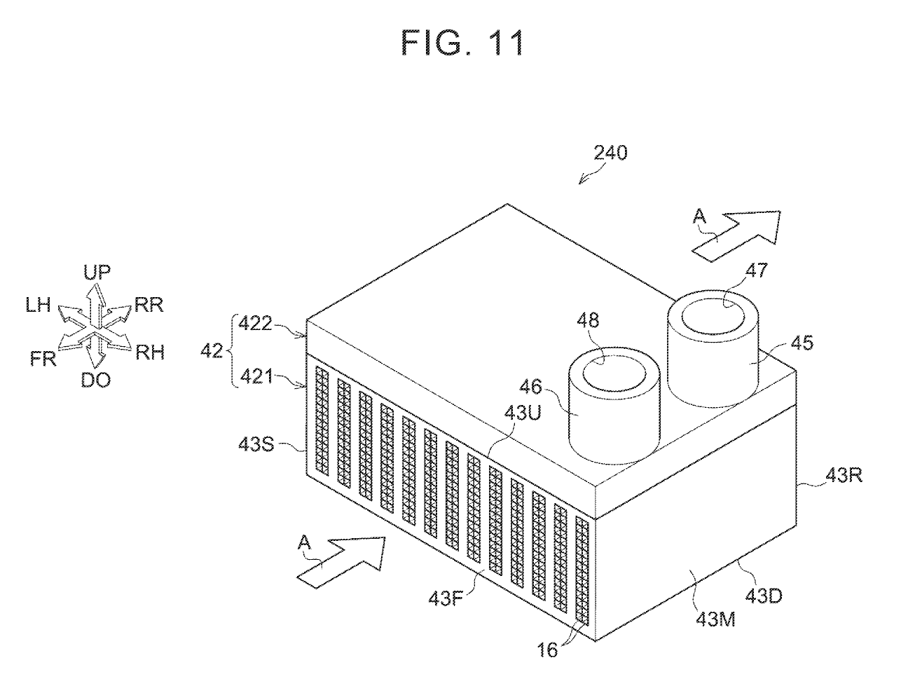

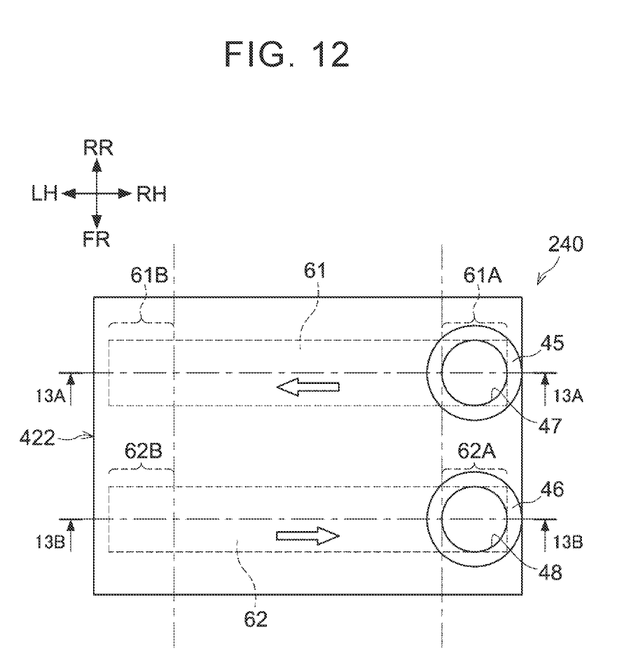

As shown in FIG. 11 and FIG. 12, in the heat exchanger 240 according to the second modification, the outlet portion 46 is disposed in a front right portion of the second flow passage forming body 422. The first flow passage forming body 421 of the heat exchanger 240 is structured similarly to the first flow passage forming body 421 of the heat exchanger 40.

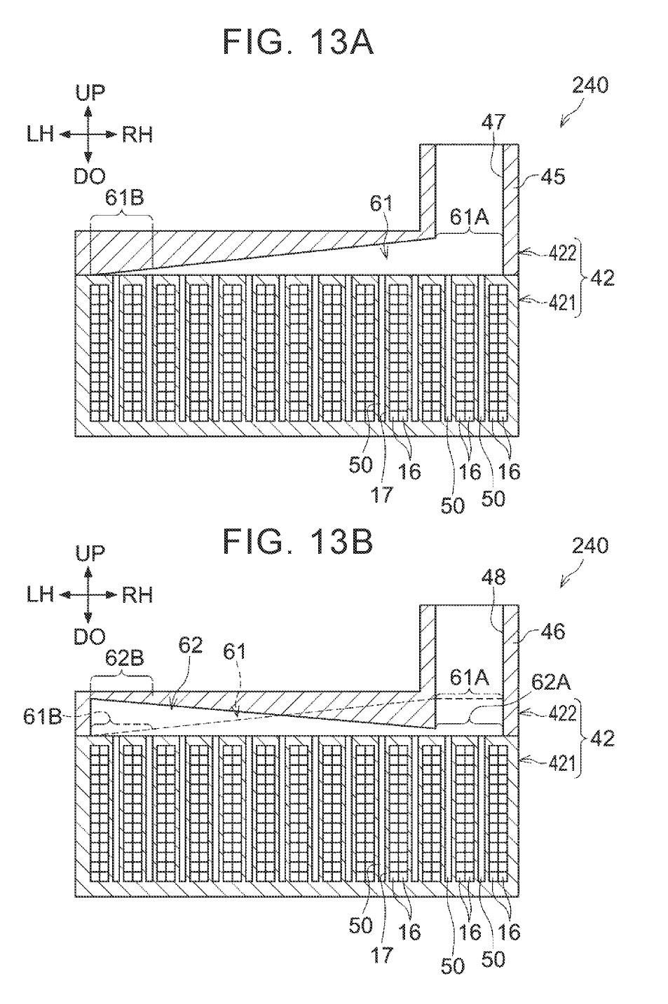

As shown in FIG. 13A, a height of the introduction path 61 along the upward-downward direction (an example of a length along the third direction) is reduced gradually from the right end portion 61A (an example of the upstream end portion, an example of an end portion on the one side) to the left end portion 61B (an example of the downstream end portion, an example of an end portion on the other side) of the introduction path 61. To be specific, in a front view, the introduction path 61 is formed into a tapered shape in which the height is reduced gradually from the right side to the left side.

The right end portion 61A of the introduction path 61 is a portion of an upstream end of a flow direction (leftward) in which the heating medium is caused to flow by the introduction path 61. This means that the right end portion 61A is an end portion close to the inlet portion 45. The right end portion 61A communicates with the flow passage 47 in the inlet portion 45, and also communicates with the rightmost introduction port 511 (see FIG. 3). The height of the introduction path 61 is set to be the largest in the right end portion 61A.

The left end portion 61B of the introduction path 61 is a portion of a downstream end of the flow direction (leftward) in which the heating medium is caused to flow by the introduction path 61. This means that the left end portion 61B is an end portion far from the inlet portion 45. The left end portion 61B communicates with the leftmost introduction port 511. Further, the height of the introduction path 61 is set to be the smallest in the left end portion 61B.

Further, the right end portion 62A of the discharge path 62 communicates with the flow passage 48 in the outlet portion 46. Then, the discharge path 62 allows the heating medium from the downstream portions 52 (see FIG. 1) of the heating medium passages 50 to flow to the right, and discharges the heating medium to the outlet portion 46. As shown in FIG. 12, in a planar view, the outlet portion 46 is disposed so as to overlap the right end portion 62A of the discharge path 62.

As shown in FIG. 13B, a height of the discharge path 62 along the upward-downward direction (an example of a length along the third direction) increases gradually from the right end portion 62A (an example of the first portion, an example of an end portion on the one side) toward the left end portion 62B (an example of the second portion, an example of an end portion on the other side) of the discharge path 62. To be specific, in a front view, the discharge path 62 is formed into a tapered shape in which the height increases gradually from the right side towards the left side.

The right end portion 62A of the discharge path 62 is a portion of a downstream end of the flow direction (rightward) in which the heating medium is caused to flow by the discharge path 62. The right end portion 62A communicates with the flow passage 48 in the outlet portion 46, and also communicates with the rightmost discharge port 522 (see FIG. 3). Further, as shown in FIG. 12, the right end portion 62A is a portion disposed in front of the right end portion 61A of the introduction path 61. Thus, the right end portion 62A is an example of the first portion that is disposed in front (a downstream side of a flow direction of the heating medium flowing in the heating medium passages 50) of the right end portion 61A (the upstream end portion) of the introduction path 61. As shown in FIG. 13B, in a front view, the right end portion 62A overlaps a part of the right end portion 61A of the introduction path 61. Further, the height of the discharge path 62 is set to be the lowest in the right end portion 62A.

The left end portion 62B of the discharge path 62 is a portion of an upstream end of the flow direction (rightward) in which the heating medium is caused to flow by the discharge path 62. The left end portion 62B communicates with the leftmost discharge port 522. Further, as shown in FIG. 12, the left end portion 62B is a portion that is disposed in front of the left end portion 61B of the introduction path 61. Thus, the left end portion 62B is an example of the second portion that is disposed in front (the downstream side of the flow direction of the heating medium flowing in the heating medium passages 50) of the left end portion 61B (the downstream end portion) of the introduction path 61. As shown in FIG. 13B, in a front view, the left end portion 62B partially overlaps the left end portion 61B of the introduction path 61. Also, the height of the discharge path 62 is set to be the largest in the left end portion 62B.

Action effects of heat exchanger 240 according to the second modification are described below. As shown in FIG. 13A, in the heat exchanger 240, the height of the introduction path 61 is reduced gradually from the right end portion 61A towards the left end portion 61B of the introduction path 61. This means that the height of the introduction path 61 is reduced gradually from the right end portion 61A close to the inlet portion 45 towards the left end portion 61B far from the inlet portion 45. Thus, the longer the distance from the inlet portion 45 becomes, the smaller a sectional area of the introduction path 61 becomes.

Meanwhile, as shown in FIG. 13B, the height of the discharge path 62 increases gradually from the right end portion 62A towards the left end portion 62B of the discharge path 62.

Here, the right end portion 62A of the discharge path 62 is disposed in front of the right end portion 61A of the introduction path 61. Therefore, the heating medium that flows in the heating medium passages 50 to the front from the right end portion 61A of the introduction path 61 close to the inlet portion 45 is discharged to the right end portion 62A of the discharge path 62.

The left end portion 62B of the discharge path 62 is disposed in front of the left end portion 61B of the introduction path 61. Therefore, the heating medium that flows in the heating medium passages 50 to the front from the left end portion 61B of the introduction path 61 far from the inlet portion 45 is discharged to the left end portion 62B of the discharge path 62.

As described earlier, the height of the discharge path 62 increases gradually from the right end portion 62A towards the left end portion 62B of the discharge path 62. Therefore, a sectional area of the discharge path 62 becomes larger on the discharge side of the heating medium passages 50 disposed on a side far from the inlet portion 45 (the left side) than that on the discharge side of the heating medium passages 50 disposed on a side close to the inlet portion 45 (the right side).

As described so far, the sectional area of the introduction path 61 is reduced gradually from the right end portion 61A close to the inlet portion 45 towards the left end portion 61B far from the inlet portion 45. Also, the sectional area of the discharge path 62 becomes larger on the discharge side of the heating medium passages 50 on the side far from the inlet portion 45 (the left side) than that on the discharge side of the heating medium passages 50 on the side close to the inlet portion 45 (the right side). Thus, it is possible to restrain variation in flow resistance among a plurality of routes from the inlet portion 45 to the outlet portion 46 through the respective heating medium passages 50. Hence, the heating medium flowing in the heating medium passages 50 is restrained from having variation in flow rate between the heating medium passages 50 disposed on the side close to the inlet portion 45 (the right side), and the heating medium passages 50 disposed on the side far from the inlet portion 45 (the left side). As described above, in the heat exchanger 240 in which the inlet portion 45 communicates with the right end portion 61A of the introduction path 61, and the outlet portion 46 communicates with the right end portion 62A of the discharge path 62, the heating medium flowing in the heating medium passages 50 is also restrained from having variation in flow rate among the heating medium passages 50. Therefore, it is possible to improve heat exchange efficiency.

In the embodiment, exhaust gas is used as high-temperature gas. However, the disclosure is not limited to this. As the high-temperature gas, any gas may be applied as long as it has temperature higher than that of the heating medium.

In the embodiment, coolant is used as the heating medium. However, the disclosure is not limited to this. As the heating medium, for example, ATF fluid and CVT fluid may be used, and a wide range of fluid such as liquid and gas used for heat exchange may be applied.

In the embodiment, the case is explained where the heat exchanger 40 is applied to the waste heat recovery structure 10. However, the disclosure is not limited to this case. The heat exchanger 40 may be applied to other structures.

In the embodiment, a material for the heat exchanger body 42 including the inlet portion 45 and the outlet portion 46 (the second flow passage forming body 422 and the first flow passage forming body 421) is, but not limited to, silicon carbide. A material other than silicon carbide may be used to form the heat exchanger body 42.

In the embodiment, the flow direction of exhaust gas (rearward) in the gas passages 16 and the flow direction of the heating medium (frontward) in the heating medium passages 50 are opposite to one another. However, the flow direction of exhaust gas and the flow direction of the heating medium may be the same. Specifically, by allowing exhaust gas to flow in the gas passages 16 to the front, it is possible to equalize the flow direction of exhaust gas and the flow direction of the heating medium.

The disclosure is not limited to the embodiment described above, and various modifications, changes, and improvements may be made without departing from the gist of the disclosure.

What is claimed is:

1. A heat exchanger comprising:
a heat exchanger body having a size in a first direction, a second direction, and a third direction that are orthogonal to each other;
a plurality of gas passages that goes through the heat exchanger body in the first direction in a state where the gas passages are partitioned from an inside of the heat exchanger body, the gas passages being disposed in the second direction, and allowing high-temperature gas to flow to one side in the first direction;
a plurality of heating medium passages that is formed inside the heat exchanger body, disposed alternately with the gas passages in the second direction, and allows heating medium to flow in a flow direction along the one side or the other side in the first direction, the heating medium exchanging heat with high-temperature gas flowing in the gas passages;
an inlet portion that is provided in the heat exchanger body and introduces the heating medium from an outside to the inside of the heat exchanger body;
an outlet portion that is provided in the heat exchanger body and discharges the heating medium from the inside to the outside of the heat exchanger body;
an introduction path that is formed inside the heat exchanger body, allows the heating medium introduced from the inlet portion to flow in the second direction, and thus introduces the heating medium to upstream portions of the heating medium passages, the introduction path having a length along the third direction, the length being reduced gradually from an upstream end portion of the introduction path towards a downstream end portion of the introduction path; and
a discharge path that is formed inside the heating exchanger body, allows the heating medium discharged from the downstream portions of the heating medium passages to flow in the second direction, and thus discharges the heating medium to the outlet portion, the discharge path having a length along the third direction, the length increasing gradually from a first portion towards a second portion, the first portion being disposed downstream of the upstream end portion of the introduction path in the flow direction, and the second portion being disposed downstream of the downstream end portion of the introduction path in the flow direction.

2. The heat exchanger according to claim 1, wherein:
the inlet portion communicates with a first end portion of the introduction path on one side in the second direction;
the outlet portion communicates with a second end portion of the discharge path on the other side in the second direction;
the introduction path allows the heating medium introduced from the inlet portion to flow from the one side to the other side, and thus introduces the heating medium to the upstream portions of the heating medium passages, the introduction path having the length along the third direction, the length being reduced gradually from the first end portion of the introduction path on the one side, to a second end portion of the introduction path on the other side; and
the discharge path allows the heating medium discharged from the downstream portions of the heating medium passages to flow from the one side to the other side, and thus discharges the heating medium to the outlet portion, the discharge path having a length along the third direction, the length increasing gradually from a first end portion of the discharge path on the one side serving as the first portion to the second end portion of the discharged path on the other side serving as the second portion.

3. The heat exchanger according to claim 1, wherein:
the inlet portion communicates with a portion of the introduction path on a center side in the second direction;
the outlet portion communicates with a portion of the discharge path on a center side of in the second direction;
the introduction path allows the heating medium introduced from the inlet portion to flow from the center side to the one side and the other side in the second direction, and thus introduces the heating medium to the upstream portions of the heating medium passages, the introduction path having the length along the third direction, the length being reduced gradually from the portion on the center side to first and second end portions on the one side and the other side; and
the discharge path allows the heating medium discharged from the downstream portions of the heating medium passages to flow from the one side and the other side to the center side, and thus discharges the heating medium to the outlet portion, the discharge path having a length along the third direction, the length increasing gradually from a portion on the center side serving as the first portion to first and second end portions on the one side and the other side serving as the second portions.

4. The heat exchanger according to claim 1, wherein:
the inlet portion communicates with a first end portion of the introduction path on the one side in the second direction;
the outlet portion communicates with a first end portion of the discharge path on the one side in the second direction;
the introduction path allows the heating medium introduced from the inlet portion to flow from the one side to the other side in the second direction, and thus introduces the heating medium to the upstream portions of the heating medium passages, the introduction path having the length along the third direction, the length being reduced gradually from the first end portion on the one side to a second end portion on the other side; and
the discharge path allows the heating medium discharged from the downstream portions of the heating medium passages to flow from the other side to the one side, and thus discharges the heating medium to the outlet portion, the discharge path having a length along the third direction, the length increasing gradually from the first end portion on the one side serving as the first portion to a second end portion on the other side serving as the second portion.

5. The heat exchanger according to claim 1, wherein the heat exchanger body, the inlet portion, and the outlet portion are formed integrally from silicon carbide.

6. A waste heat recovery structure comprising:
an exhaust pipe in which exhaust gas flows; and
the heat exchanger according to claim 1 in which the heat exchanger body is provided inside the exhaust pipe, and the exhaust gas serving as high-temperature gas flows in the gas passages.
